(19) United States
(12) Patent Application Publication
(10) Pub. No.: US 2016/0037817 A1
(43) Pub. Date: Feb. 11, 2016

(54) COMPOSITION COMPRISING A MULTIFUNCTIONAL VISCOSITY MODIFYING AGENT

(71) Applicant: ABBOTT LABORATORIES, Abbott Park, IL (US)

(72) Inventors: Paul Johns, Columbus, OH (US); Steven Dimler, Pickerington, OH (US); Mustafa Vurma, Dublin, OH (US)

(73) Assignee: ABBOTT LABORATORIES, Abbott Park, IL (US)

(21) Appl. No.: 14/774,526

(22) PCT Filed: Feb. 28, 2014
(86) PCT No.: PCT/US14/19494

§ 371 Date: Sep. 10, 2015

Related U.S. Application Data
(60) Provisional application No. 61/777,490, filed on Mar. 12, 2013.

(51) Int. Cl. A23L 1/304; A23L 1/29; A23L 1/305

(52) U.S. Cl. CPC A23L 1/304; A23L 1/305; A23L 1/296; A23V 2002/00

(57) ABSTRACT

A nutritional composition comprising at least one protein, at least one macronutrient other than the at least one protein, and micronized calcium phosphate. The micronized calcium phosphate has a median particle size from about 0.20 to about 1.20 micrometers and may modify the viscosity of the nutritional composition. The micronization of the calcium phosphate may provide for increased bioavailability of calcium and phosphate and protein stability in the nutritional composition.

### CROSS REFERENCE TO RELATED APPLICATIONS

This application claims priority to and any benefit of U.S. Provisional Application No. 61/777,490, filed Mar. 12, 2013, the entire content of which is incorporated herein by reference.

### FIELD OF THE DISCLOSURE

The present disclosure relates to nutritional compositions comprising protein and micronized calcium phosphate. The micronized calcium phosphate can impact the viscosity, protein stability and mineral bioavailability of the nutritional compositions.

### BACKGROUND OF THE DISCLOSURE

Protein and minerals are commonly found in nutritional compositions, such as liquids and reconstituted powders, in order to provide health benefits to the consumer. Yet these components may interact in solution to produce consumer unacceptable product characteristics. For example, the solubility characteristics of some minerals, particularly calcium, can negatively impact protein stability in solution. The destabilization of proteins can result in denatured protein that precipitates out of solution such that it clings to the sides or bottom of the liquid delivery/reconstitution container. Consequently, at least a portion of the protein in the nutritional composition may not actually be ingested by the consumer.

Conventional wisdom would dictate that to maximize the bioavailability of minerals to the consumer, nutritional compositions should comprise soluble instead of insoluble sources of the minerals. This is supported by the current incorporation of soluble calcium sources (e.g., calcium gluconate, calcium beta-hydroxy-beta-methyl-butyrate, and calcium glycerophosphate) in commercially available human milk fortifier powders. Yet as noted above, soluble calcium in particular may cause the proteins present in the nutritional composition to come out of solution.

Beyond providing for good nutrition, it is important for nutritional compositions to have consumer acceptable characteristics. Good taste and appearance can be important to the consumer, as can a liquid's viscosity. Viscosity may not only influence palatability, but it can also impact the ability of dysphagic individuals to swallow a liquid. Thus, thixotropic agents such as carrageenan are typically added to commercial nutritional compositions to achieve the viscosity desired in the finished product. However, thixotropic agents have been the subject of increased regulation surrounding their use as a food additive. Moreover, thixotropic agents typically do not additionally provide significant nutritional benefits.

Thus there remains a need for liquid nutritional compositions comprising proteins in combination with increased bioavailable minerals, which also provide the desired viscosity without requiring thixotropic agents. Moreover, there is a need for a viscosity modifier that also provides nutritional benefits.

### SUMMARY OF THE DISCLOSURE

The present disclosure provides for a liquid or reconstitutable nutritional composition that simultaneously meets all of the aforementioned needs. It has been surprisingly discovered that these needs are met by incorporating micronized calcium phosphate as a viscosity modifying agent into the nutritional composition, despite the general recognition that calcium phosphate is an insoluble salt. Surprisingly, insoluble calcium phosphate micronized to a certain median particle size increases the solubility of the calcium present in the micronized calcium phosphate. Thus when the micronized calcium phosphate is added to a nutritional composition, there is an increase in the bioavailability of the calcium in conjunction with modified viscosity and protein stability. The following non-limiting embodiments of the present disclosure incorporate this recent discovery.

In some embodiments, a nutritional composition comprises at least one protein, at least one macronutrient other than the at least one protein, and micronized calcium phosphate having a median particle size from about 0.20 to about 1.20 micrometers, such that the composition has a viscosity from about 5 to about 5,000 centipoise (“cp”).

In a further embodiment, a method of modifying the viscosity of a liquid nutritional composition comprising stabilized proteins is provided. The method comprises the step of adding micronized calcium phosphate having a median particle size from about 0.20 to about 1.20 micrometers to a nutritional composition comprising at least one protein and at least one macronutrient other than the at least one protein. The resulting composition, for example a ready-to-feed liquid, a concentrated liquid or a reconstituted liquid, may have a viscosity from about 5 to about 5,000 cp.

### BRIEF DESCRIPTION OF THE FIGURES

FIG. 1 is a plot showing viscosity variation with respect to low soluble calcium concentrations.

FIG. 2 is a plot showing viscosity variation with respect to high soluble calcium concentrations.

### DETAILED DESCRIPTION OF THE INVENTION

The elements or features of the various embodiments are described in detail hereinafter.

The various embodiments of the nutritional products of the present disclosure may be “free” or “substantially free” of any optional or selected ingredient or feature described herein, provided that the remaining nutritional product still contains all of the required ingredients or features as described herein. In this context, and unless otherwise specified, the term “substantially free” means that the selected nutritional product contains less than a functional amount of the optional ingredient, typically less than about 1%, including less than about 0.5%, including less than about 0.1%, and also including zero percent, by weight of such optional or selected ingredient.

The terms “fat,” “oil” and “lipid” as used herein, unless otherwise specified, are used interchangeably to refer to lipid materials derived or processed from plants or animals. These terms also include synthetic lipid materials so long as such synthetic materials are suitable for oral administration to humans.

The terms “infant formula,” “product,” “nutritional product,” or “nutritional composition,” as used herein, are used interchangeably and, unless otherwise specified, refer to nutritional liquids, nutritional semi-liquids, nutritional semi-solids, and nutritional powders. The nutritional powders may be reconstituted to form a nutritional liquid, all of which comprise at least one macronutrient, which may be selected from the group consisting of fat, protein and carbohydrate and which are suitable for oral consumption by a human.

“Nutritional liquid,” as used herein, unless otherwise specified, refers to nutritional products in ready-to-drink liquid form, concentrated form, and nutritional liquids made by reconstituting the nutritional powders described herein prior to use.

“Nutritional powder,” or “reconstitutable powder” as used interchangeably herein unless otherwise specified, refers to nutritional products in flowable or scoopable form that can be reconstituted with water or another aqueous liquid prior to consumption and includes both spray dried and drymixed/dryblended powders. The nutritional powders may be compressed to form a “unit dose” of the nutritional composition, which may be individually packaged or made into a solid form such as a tablet so that no measuring of the nutritional composition is needed prior to reconstitution.

The term “infant formula,” as used herein, refers to nutritional products that are designed specifically for consumption by an infant.

The term “bioavailability” as used herein, unless otherwise specified, refers to the ability of a compound to enter into and remain in the bloodstream of an individual such that the substance can be absorbed into cells in the body. As the degree of bioavailability of a compound increases, the compound becomes more likely to enter into and remain in the bloodstream where it can be absorbed and used by the body. As the degree of bioavailability of a compound decreases, the compound becomes more likely to go directly into the gastrointestinal area and be expelled from the body before entering the bloodstream.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified. All numerical ranges as used herein, whether or not expressly preceded by the term “about,” are intended and understood to be preceded by that term, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 5 to 6, from 1 to 9, from 3.6 to 4.6, from 3.5 to 9.9, and so forth.

Any reference to a singular characteristic or limitation of the present disclosure shall include the corresponding plural characteristic or limitation, and vice versa, unless otherwise specified or clearly implied to the contrary by the context in which the reference is made.

Any combination of method or process steps as used herein may be performed in any order, unless otherwise specifically or clearly implied to the contrary by the context in which the referenced combination is made.

The nutritional compositions and methods may comprise, consist of, or consist essentially of the elements and features of the disclosure described herein, as well as any additional or optional ingredients, components, or features described herein or otherwise useful in a nutritional application.

All documents (patents, patent applications and other publications) cited in this application are incorporated herein by reference in their entirety.

Product Form

The nutritional compositions of the present disclosure may be formulated and administered in any suitable oral product form. Any liquid, reconstitutable powder or reconstitutable solid forms (for example, tablets), including combinations or variations thereof, are suitable for use herein, provided that such forms allow for safe and effective oral delivery to the individual of the nutritional ingredients as described herein. The nutritional compositions may be formulated to include only the ingredients described herein, or may be modified with optional ingredients to form a number of different product forms.

The nutritional compositions of the present disclosure may be formulated as dietary product forms, which are defined herein as embodiments comprising at least one protein, at least one macronutrient other than the at least one protein, and micronized calcium phosphate. Non-limiting examples of macronutrients may be selected from the group of: fat; protein; carbohydrate; and combinations thereof.

The nutritional compositions of the present disclosure may provide either a sole source or a supplemental source of nutrition to an individual. In this context, a sole source of nutrition is one that can be administered once or multiple times each day to potentially provide an individual with all or substantially all of their fat, protein, carbohydrate, mineral, and vitamin needs per day or during the intended period of administration. A supplemental source of nutrition is defined herein as a dietary source that does not provide an individual with a potentially sole source of nutrition. The nutritional compositions of the present disclosure may be formulated with any suitable liquid base. Non-limiting examples of useful liquid bases include: milk-based liquids, soy-based liquids, low-pH liquids, clear liquids, and reconstitutable powders.

Nutritional Liquids

Nutritional liquids include concentrated and ready-to-feed liquid product forms. Non-limiting examples of liquid product forms suitable for use herein include liquid infant formulas (including both ready-to-feed formulations and concentrated formulations), liquid toddler formulas (including both ready-to-feed formulations and concentrated formulations), liquid human milk fortifiers (including both ready-to-feed and concentrated formulations), snack and meal replacement products, hot or cold beverages, carbonated or non carbonated beverages, juices or other acidified beverages, shakes, coffees, teas, enteral feeding compositions, and so forth. These liquid compositions are most typically formulated as suspensions or emulsions, but can also be formulated in any other suitable form such as clear liquid solutions, liquid gels, and so forth. Nutritional liquids according to the present disclosure have a viscosity of from about 5 to about 5,000 cp, from about 5 to about 2,000 cp, from about 5 to about 1,000 cp, from about 5 to 100 cp, from about 10 to about 80 cp, from about 10 to about 50 cp, or from about 15 to about 40 cp.

The nutritional liquid beverages of the present disclosure may be used as nutritional drinks for pre-term infants, infants, toddlers, children, and adults, including geriatric patients. The liquid beverages may also be used as semi-elemental formulas for the nutritional needs of patients with malabsorption, maldigestion and other gastrointestinal conditions.

Nutritional emulsions suitable for use may be aqueous emulsions comprising proteins, fats, carbohydrates, and combinations thereof. These emulsions are generally flowable or drinkable liquids at from about 1° C. to about 25° C. and are typically in the form of oil-in-water, water-in-oil, or complex aqueous emulsions, although such emulsions are most typically in the form of oil-in-water emulsions having a continuous aqueous phase and a discontinuous oil phase.

The nutritional emulsions may be and typically are shelf stable. The nutritional emulsions typically contain up to about 95% by weight of water, including from about 50% to about 95%, also including from about 60% to about 90%, and also including from about 70% to about 88%, of water by weight of the nutritional emulsions. The nutritional emulsions may have a variety of product densities, but most typically have a density greater than about 1.03 g/ml, including greater than about 1.04 g/ml, including greater than about 1.055 g/ml, including from about 1.06 g/ml to about 1.12 g/ml, and also including from about 1.085 g/ml to about 1.10 g/ml.

The nutritional emulsions may have a caloric density tailored to the nutritional needs of the ultimate user, although in most instances the emulsions comprise from about 100 to about 500 kcal/240 ml, including from about 150 to about 350 kcal/240 ml, and also including from about 200 to about 320 kcal/240 ml.

In some embodiments, the nutritional emulsion may be a low-calorie nutritional emulsion having a caloric density of about 6.5 kcal/fl oz (52.8 kcal/240 ml). In some embodiments, the nutritional emulsion has a caloric density of about 7.1 kcal/fl oz (57.6 kcal/240 ml). In some embodiments the nutritional emulsion has a caloric density of about 7.7 kcal/fl oz (62.4 kcal/ml).

The nutritional emulsion may have a pH ranging from about 6.6 to about 7.0.

Although the serving size for the nutritional emulsion can vary depending upon a number of variables, a typical serving size ranges from about 100 to about 300 ml, including from about 150 to about 250 ml, and including from about 190 ml to about 240 ml. In embodiments in which the nutritional emulsion is used as a human milk fortifier, a typical single serving size is about 5.0 ml.

Nutritional Solids

The nutritional solids may be in any solid form but are typically in the form of flowable or substantially flowable particulate compositions, or at least particulate compositions. Particularly suitable nutritional solid product forms include spray dried, agglomerated or dryblended powder compositions. In some embodiments, these products may be subsequently compressed into a unit dose form such as a tablet, which may be added to an aqueous liquid such as water and reconstituted to form a liquid nutritional product. The powder compositions may be easily be scooped and measured with a spoon or similar other devices, wherein the compositions can easily be reconstituted by the intended user with a suitable aqueous liquid, typically water, to form a nutritional formulation for immediate oral or enteral use. In this context, “immediate” use generally means within about 48 hours, most typically within about 24 hours, preferably right after reconstitution.

The nutritional powders may be reconstituted with water prior to use to a caloric density tailored to the nutritional needs of the ultimate user, although in most instances the powders are reconstituted with water to form compositions comprising from about 100 to about 500 kcal/240 ml, including from about 150 to about 350 kcal/240 ml, and also including from about 200 to about 320 kcal/240 ml.

In alternative embodiments, the nutritional powder may be reconstituted with water to form a low-calorie composition having a caloric density of about 52.8 kcal/240 ml. In another embodiment, the nutritional powder has a caloric density of about 57.6 kcal/240 ml. In one embodiment, the nutritional powder has a caloric density of about 62.4 kcal/240 ml.

Although the serving size for the reconstituted nutritional liquid can vary depending upon a number of variables, a typical serving size ranges from about 100 to about 300 ml, including from about 150 to about 250 ml, including from about 190 ml to about 240 ml.

In some embodiments, the reconstituted nutritional liquid can be used as a human milk fortifier. In such embodiments, a typical single serving size includes about 0.9 grams of powder per about 25 to about 50 ml of human milk.

The reconstituted nutritional liquid according to the present disclosure have a viscosity of from about 5 to about 5,000 cp, from about 5 to about 2,000 cp, from about 5 to about 1,000 cp, from about 5 to 100 cp, from about 10 to about 80 cp, from about 10 to about 50 cp, or from about 15 to about 40 cp.

Method of Manufacture

The nutritional compositions of the present disclosure may be prepared by any known or otherwise effective manufacturing technique for preparing the selected product liquid, powder or solid form. Many such techniques are known for any given product and can easily be applied by one of ordinary skill in the art to the nutritional compositions described herein.

For example, in one suitable manufacturing process, at least three separate slurries are prepared, including a protein-in-fat (PIF) slurry, a carbohydrate-mineral (CHO-MIN) slurry, a protein-in-water (PIW) slurry. The PIF slurry is formed by heating and mixing the oil (e.g., canola oil, corn oil, etc.) and then adding an emulsifier (e.g., lecithin), fat soluble vitamins, and a portion of the total protein (e.g., milk protein concentrate, etc.) with continued heat and agitation.

The CHO-MIN slurry is formed by adding with heated agitation to water: micronized calcium phosphate, other minerals (e.g., potassium citrate, dipotassium phosphate, sodium citrate, etc.), trace and ultra trace minerals (TM/UTM premix), and optionally, an additional thickening or suspending agents (e.g. Avicel® (FMC Biopolymer (Philadelphia, Pa.), gellan gum, carrageenan)). The resulting CHO-MIN slurry is held for 10 minutes with continued heat and agitation before adding additional minerals (e.g., potassium chloride, magnesium carbonate, potassium iodide, etc.), and/or carbohydrates (e.g., fructooligosaccharide, sucrose, corn syrup, etc.). The PIW slurry is then formed by mixing with heat and agitation the remaining protein, if any.

The resulting slurries are then blended together with heated agitation and the pH adjusted to 6.6-7.0, after which the composition is subjected to high-temperature short-time (HTST) processing during which the composition is heat treated, emulsified and homogenized, and then allowed to cool. Water soluble vitamins and ascorbic acid are added, the pH is adjusted to the desired range if necessary, flavors are added, and water is added to achieve the desired total solid level. The composition is then aseptically packaged to form an aseptically packaged nutritional emulsion. This emulsion can then be further diluted, heat-treated, and packaged to form a ready-to-feed or concentrated liquid, or it can be heat-treated and subsequently processed and packaged as a reconstitutable powder, e.g., spray dried, dry mixed, agglomerated. In a further embodiment, the powder may then be compressed into a unit dose form such as a tablet.

When a substantially clear liquid beverage is desired, the above described manufacturing process is modified such that only a CHO-MIN slurry and a PIW slurry are blended to form the nutritional liquid beverage.

Other suitable methods for making nutritional products are described, for example, in U.S. Pat. No. 6,365,218 (Borschel, et al.), U.S. Pat. No. 6,589,576 (Borschel, et al.), U.S. Pat. No. 6,306,908 (Carlson, et al.) and U.S. Pat. No. 6,811,801 (Nguyen, et al.), which descriptions are incorporated herein by reference to the extent that they are consistent herewith.

### Components of the Nutritional Composition

Micronized Calcium Phosphate

Any suitable micronized calcium phosphate having a median particle size of from about 0.20 to about 1.20 μm, from about 0.20 to about 1.0 μm, from about 0.20 to about 1.0 μm, or from about 0.40 to about 0.80 μm, may be utilized in the present nutritional compositions. Non-limiting examples of useful micronized calcium phosphate may be selected from the group of: tricalcium phosphate; dicalcium phosphate; hydroxyapatite; and combinations thereof.

Micronized calcium phosphate having the desired median particle size may be prepared using any suitable method. One useful method is to subject the calcium phosphate to cryomilling with a liquid refrigerant. A number of factors may determine the desired level of micronized calcium phosphate in the liquid nutritional composition. Non-limiting examples of such factors include product viscosity, protein stability and calcium phosphate bioavailability. To achieve a product viscosity of from about 5 cp to about 5,000 cp, useful ranges of micronized calcium may include in term of grams of micronized calcium phosphate to kg of the nutritional composition, from about 1 g/kg to about 5 g/kg, or from about 1 g/kg to about 3 g/kg. In some embodiments, the micronized calcium phosphate is present in the nutritional composition in a weight percentage of from about 0.001% to about 1.0%, from about 0.005% to about 0.50%, or from about 0.10% to about 0.40%.

The median particle size of the micronized calcium phosphate according to the present disclosure may provide a soluble calcium concentration of from about 0.1% to about 95%, from about 1% to about 50%, or from about 5% to about 30% of the total theoretical calcium. Theoretical calcium is the calcium concentration calculated according to the molecular formula. For example, with respect to commercial tricalcium phosphate (TCP), which is chemically known as hydroxyapatite, the molecular formula is Ca₅HO₁₃P₃, and the molecular weight is 502.31. Accordingly, the theoretical calcium concentration is (5×40.08)/502.31=39.90%, w/w. The micronized calcium phosphate contributes to the total calcium and total phosphate that is present in the nutritional composition, hence adding further nutritive value in addition to modifying the viscosity of the nutritional composition. Further calcium may be contributed to the total calcium when it is added to the nutritional composition in addition to the micronized calcium phosphate or it is inherently found in other components of the nutritional products. Non-limiting examples of these components may be selected from the group: calcium caseinate; Fibrim® (Essex Grain Products, Inc., Linden, N.J.); Maltrin® M100® (GPC™, Muscatine, Iowa); and Fructose.

The total calcium may be present in the nutritional composition at a weight percentage of the composition of from about 0.02% to about 0.20%, from about 0.03% to 0.18%, or from about 0.04% to 0.15%. The total phosphorous may be present in the nutritional composition at a weight percentage of the composition of from about 0.01% to about 0.50%, from about 0.02% to 0.40%; or from about 0.03% to about 0.30%.

The weight ratio of total calcium to total phosphorus can carry nutritional significance. For example, the molar ratio of calcium to phosphorus is typically close to 1 for most nutritional products. An excess of phosphorus with respect to calcium may be undesirable from a nutritional perspective. The weight ratio of total calcium to total phosphorus in the composition may be from about 0.5 to about 3.0, or from about 0.8 to about 2.20, or from about 1.0 to about 2.0. The weight ratio of total protein to total calcium in the composition may be from about 10:1 to about 100:1, or from about 20:1 to about 90:1, or from about 25:1 to about 85:1.

The soluble calcium may be present in the nutritional composition at a weight percentage of the nutritional composition of from about 0.001 to about 0.100%, from about 0.005% to 0.050%; or from about 0.010% to 0.030%. The weight ratio of soluble calcium to phosphate can be important, because the phosphate is a strong binder of calcium such that soluble calcium would be expected to decrease as concentration of phosphate increases. Useful weight ratios of soluble calcium to total phosphate in the composition are from about 0.003 to about 1.00, from about 0.01 to about 0.50, or from about 0.02 to about 0.20.

The nutritional composition may comprise a calcium phosphate fortification rate in the range of from about 0.5 to about 10 g/kg, or from about 1.0 to about 5.0 g/kg, or from about 2.0 to about 4.0 g/kg of the as-fed nutritional composition.

In some embodiments, the micronized calcium phosphate having a median particle size of from about 0.20 μm to about 1.20 μm per the present disclosure, may be the only viscosity modifier in the nutritional composition. In other words, the nutritional composition may be substantially free or free of viscosity modifiers including, but not limited to: carrageenan, xanthan gum, gellan gum, gum Arabic, carboxymethylcellulose, etc.

Protein

The nutritional compositions of the present disclosure comprise at least one protein. Proteins may be “calcium-sensitive,” meaning that they may be susceptible to destabilization in solution by calcium. Grams of protein may be present per kilogram of the as-fed nutritional compositions at from about 5 g/kg to about 100 g/kg. In some embodiments, the nutritional compositions may be substantially free or free of proteins that are not calcium sensitive.

Non-limiting examples suitable protein or sources thereof for use in the nutritional compositions may be selected from the group of: hydrolyzed; partially hydrolyzed; non-hydrolyzed; and combinations thereof. The proteins may be derived from any known or otherwise suitable source including, but not limited to: milk, animal (e.g., meat, fish), cereal (e.g., rice, corn), vegetable (e.g., soy) or combinations thereof. Non-limiting examples of vegetable proteins may be selected from the group of: soy protein isolates; soy protein concentrates; soy protein hydrolysates; and mixtures thereof.

In some embodiments, the protein source of the protein component of the nutritional compositions of the present disclosure may be at least partially comprised of hydrolyzed casein. In some embodiments, the protein source of the protein component of the nutritional compositions is entirely comprised of hydrolyzed casein such that the product would be hypoallergenic. In embodiments wherein additional protein sources (i.e., one or more protein sources in addition to the hydrolyzed protein source) are to be used in the nutritional compositions in addition to the hydrolyzed casein (i.e., the composition's protein supplement protein source is not 100% hydrolyzed casein), the nutritional compositions may still be made hypoallergenic by including additional hypoallergenic proteins such including, but not limited to: soy protein hydrolysate, whey protein hydrolysate, rice protein hydrolysate, potato protein hydrolysate, fish protein hydrolysate, egg albumen hydrolysate, gelatin protein hydrolysate, pea protein hydrolysate, bean protein hydrolysate, combinations of animal and vegetable protein hydrolysates, and combinations thereof.

When used in a liquid beverage, the total protein concentration in the nutritional liquid beverage may range from about 0.5% to about 40%, including from about 0.5% to about 30%, including from about 1% to about 15%, and also including from about 1% to about 10%, and also including from about 1% to about 7%, by weight of the nutritional liquid beverages. In one specific embodiment, the protein is present in a nutritional emulsion in an amount of about 6.0% by weight of the nutritional emulsion.

When used in solid nutritional products, such as nutritional powders or other products, the total protein concentration in the solid nutritional products may range from about 1.0% to about 50%, including from about 10% to about 50%, and also including from about 10% to about 30%, by weight of the solid nutritional product. In one specific embodiment, the protein is present in a spray dried nutritional powder in an amount of about 19%, by weight of the spray dried nutritional powder.

The weight ratio of total protein to total soluble calcium in the nutritional composition is important for protein stability in solution. For example, if the weight ratio is too low, the proteins may come out of solution. Thus in some embodiments of the present disclosure, the weight ratio of total protein to soluble calcium in the composition is less than about 700:1 and may be from about 200:1 to about 700:1, from about 300:1 to about 650:1, or from about 400:1 to about 600:1.

Carbohydrate

The nutritional compositions may further comprise any carbohydrates that are suitable for use in an oral nutritional product and are compatible with the elements and features of such products. Carbohydrate concentrations in the nutritional liquid beverages, for example, may range from about 5% to about 40%, including from about 7% to about 30%, including from about 10% to about 25%, by weight of the nutritional liquid beverage. In one specific embodiment, the carbohydrate is present in a nutritional emulsion in an amount of about 10.20%, by weight of the nutritional emulsion.

Carbohydrate concentrations in the solid nutritional compositions may range from about 10% to about 90%, including from about 20% to about 80%, further including from about 40% to about 60%, by weight of the solid nutritional compositions. In one specific embodiment, the carbohydrate is present in a spray dried nutritional powder in an amount of about 58%, by weight of the spray dried nutritional powder.

Non-limiting examples of suitable carbohydrates or sources thereof for use in the nutritional compositions described herein may be selected from the group of: maltodextrin; hydrolyzed or modified starch or cornstarch; glucose polymers; corn syrup; corn syrup solids; rice-derived carbohydrates; pea-derived carbohydrates; potato-derived carbohydrates; tapioca; sucrose; glucose; fructose; lactose; high fructose corn syrup; honey; sugar alcohols (e.g., maltitol, erythritol, sorbitol); artificial sweeteners (e.g., sucralose, acesulfame potassium, stevia); and combinations thereof. A particularly desirable carbohydrate is a low dextrose equivalent (DE) maltodextrin.

Fat

The nutritional compositions may further comprise fat, most typically as emulsified fat. The fat may be present in the nutritional liquid emulsion beverages in an amount of from 0% to about 30%, including 1% to about 30%, including from about 1% to about 20%, including from about 1% to about 15%, and also including from about 1.5% to about 5%, by weight of the nutritional emulsion. In one specific embodiment, a nutritional emulsion includes fat in an amount of about 1.6%, by weight of the nutritional emulsion.

It should be recognized by one skilled in the art that in some embodiments, such as in a substantially clear liquid beverage, the nutritional composition will be substantially free of fat.

When used in solid nutritional compositions, the fat may be present in an amount of from about 1% to about 35%, including from about 1% to about 20%, including from about 1% to about 15%, and also including from about 5.0% to about 10%, by weight of the solid nutritional composition. In one specific embodiment, a spray dried nutritional powder includes fat in an amount of about 7.5%, by weight of the spray dried nutritional powder.

Suitable sources of fat for use herein include any fat or fat source that is suitable for use in an oral nutritional product and is compatible with the elements and features of such products.

Non-limiting examples of suitable fats or sources thereof for use in the nutritional compositions described herein may be selected from the group of: coconut oil; fractionated coconut oil; soy oil; corn oil; olive oil; safflower oil; high oleic safflower oil; MCT oil (medium chain triglycerides); sunflower oil; high oleic sunflower oil; palm and palm kernel oils; palm olein; canola oil; marine oils; cottonseed oils; and combinations thereof.

Other Optional Ingredients

The nutritional compositions disclosed herein, including infant formulas, having the at least one of the calcium-sensitive proteins and micronized calcium phosphate of the present disclosure, may further comprise other optional components that may modify the physical, chemical, aesthetic or processing characteristics of the compositions or serve as pharmaceutical or additional nutritional components when used in the targeted population. Many such optional ingredients are known or otherwise suitable for use in medical food or other nutritional products or pharmaceutical dosage forms and may also be used in the compositions herein, provided that such optional ingredients are safe for oral administration and are compatible with the other ingredients in the selected product form.

Non-limiting examples of such optional ingredients may be selected from the group of: preservatives; anti-oxidants; emulsifying agents; buffers; fructooligosaccharides; galactooligosaccharides; human milk oligosaccharides and other prebiotics; pharmaceutical actives; additional nutrients as described herein; colorants; flavors; thickening agents and stabilizers emulsifying agents; lubricants; and combinations thereof.

Examples of suitable HMOs that may be included in the compositions of the present disclosure may be selected from the group of: lacto-N-tetraose, lacto-N-neotetraose, lacto-N-fucopentaose I, lacto-N-fucopentaose II, lacto-N-fucopentaose III, lacto-N-fucopentaose V, lacto-N-hexaose, para-lacto-N-hexaose, lacto-N-neohexaose, para-lacto-N-neohexaose, monofucosyllacto-N-hexaose II, isomeric fucosylated lacto-N-hexaose (1), monofucosyllacto-N-hexaose, isomeric fucosylated lacto-N-hexaose (3), isomeric fucosylated lacto-N-hexaose (2), difucosyl-para-lacto-N-neohexaose, difucosyl-para-lacto-N-hexaose, difucosyllacto-N-hexaose, lacto-N-neoocataose, para-lacto-N-octanose, iso-lacto-N-octaose, lacto-N-octaose, monofucosyllacto-neoocataose, monofucosyllacto-N-ocataose, difucosyllacto-N-octaose I, difucosyllacto-N-octaose II, difucosyllacto-N-neoocataose II, difucosyllacto-N-neoocataose I, lacto-N-decaose, trifucosyllacto-N-neooctaose, trifucosyllacto-N-octaose, trifucosyl-iso-lacto-N-octaose, and combinations thereof. These HMOs are described more fully in U.S. Patent Application No. 2009/0098240, which is herein incorporated by reference in its entirety. Other suitable examples of HMOs that may be included in the compositions of the present disclosure include lacto-N-difuco-hexaose II, sialylα(2-3) lactose, sialylα(2-6) lactose, sialyl-lacto-N-tetraose a, sialyl-lacto-N-tetraose b, sialyl-lacto-N-tetraose c, sialyl-fucosyl-lacto-N-tetraose I, sialyl-fucosyl-lacto-N-tetraose II, disialyl-lacto-N-tetraose, and combinations thereof.

The compositions may further comprise a sweetening agent, preferably including at least one sugar alcohol such as maltitol, erythritol, sorbitol, xylitol, mannitol, isolmalt, and lactitol, and also preferably including at least one artificial or high potency sweetener such as acesulfame K, aspartame, sucralose, saccharin, stevia, and tagatose. These sweetening agents, especially as a combination of a sugar alcohol and an artificial sweetener, are especially useful in formulating liquid beverage embodiments of the present disclosure having a desirable favor profile. These sweetener combinations are especially effective in masking undesirable flavors sometimes associated with the addition of vegetable proteins to a liquid beverage. Optional sugar alcohol concentrations in the nutritional product may range from at least about 0.01%, including from 0.1% to about 10%, and also including from about 1% to about 6%, by weight of the nutritional composition. Optional artificial sweetener concentrations may range from about 0.01%, including from about 0.05% to about 5%, also including from about 0.1% to about 1.0%, by weight of the nutritional composition.

A flowing agent or anti-caking agent may be included in the nutritional compositions such as the nutritional powders as described herein to retard clumping or caking of the powder over time and to make a powder embodiment flow easily from its container. Any known flowing or anti-caking agents that are known or otherwise suitable for use in a nutritional powder or product form are suitable for use herein, non limiting examples of which may be selected from phosphates, silicates, and combinations thereof. A non-limiting example of a useful phosphate is tricalcium phosphate, which is chemically regarded as hydroxyapatite. The concentration of the flowing agent or anti-caking agent in the nutritional composition varies depending upon the product form, the other selected ingredients, the desired flow properties, and so forth, but most typically range from about 0.1% to about 4%, including from about 0.5% to about 2%, by weight of the nutritional composition.

In some embodiments of the present disclosure, substance(s) that act as viscosity modifier(s), stabilizer(s) and/or thickening agent(s), can be included in the nutritional compositions. Any substances that are viscosity modifier(s), stabilizer(s) and/or thickening agent(s), that are known or otherwise suitable for use in a nutritional product is also suitable for use herein, some non-limiting examples of which include gums such as xanthan gum. The stabilizer(s) may represent from about 0.1% to about 5.0%, including from about 0.5% to about 3%, including from about 0.7% to about 1.5%, by weight of the nutritional composition. However, in some embodiments, the nutritional compositions may be free or substantially free of substances that are viscosity modifiers, stabilizer(s) and/or thickening agent(s), apart from the micronized calcium phosphate that is present in the composition. In other words, micronized calcium phosphate may be the only substance that is a viscosity modifier, stabilizer and/or thickening agent in or added to the nutritional composition.

The compositions may further comprise any of a variety of other vitamins or related nutrients, non-limiting examples of which may be selected from the group of: vitamin A, vitamin D, vitamin E, vitamin K, thiamine, riboflavin, pyridoxine, vitamin B₁₂, carotenoids (e.g., beta-carotene, zeaxanthin, lutein, lycopene), niacin, folic acid, pantothenic acid, biotin, vitamin C, choline, inositol, salts and derivatives thereof, and combinations thereof.

The compositions may further comprise any of a variety of other additional minerals, non-limiting examples of which include phosphorus, magnesium, iron, zinc, manganese, copper, sodium, potassium, molybdenum, chromium, chloride, and combinations thereof.

### Methods

The total soluble calcium concentration in a liquid nutritional composition is measured as follows. A sample of the liquid nutritional composition is subjected to high speed centrifugation at 31,000×g at 20° C. for 4 hours. The soluble calcium in the resulting supernatant is measured colorimetrically and is reported as g of soluble calcium per kg of supernatant.

The total soluble calcium in an aqueous suspension of tricalcium phosphate (“TCP”) is measured as follows. First, a preparation of a suspension of TCP in 0.10 M PIPES buffer, pH 6.5, is made and stirred vigorously for ten minutes. An aliquot of the suspension is syringe filtered, and the calcium in the filtrate is quantified by cresolphthalein colorimetry. The filtrate calcium is measured at a visible absorbance of 570 nm using a Beckman Model DU640 spectrophotometer.

The total soluble protein concentration of a liquid nutritional composition is measured using size exclusion chromatography (HPSEC), after subjecting a sample of the liquid nutritional composition to high speed centrifugation at 31,000×g at 20° C. for 4 hours.

The viscosity of a liquid nutritional composition is measured at room temperature (22.5° C.±0.5° C.) using a Brookfield LV (low viscosity) Series Viscometer. Brookfield LV series viscometer dial reading models include the LVF with an LV #1 spindle at 60 rpm. Before measuring the viscosity of the composition, it is agitated by hand for 10 seconds. The composition is measured when it is contained in a graduated polypropylene pitcher having a 64 mm top inner diameter and a height of 119 mm.

The particle size distribution of the micronized calcium phosphate is measured by laser diffraction using a Sympatec HELOS Model 1005. A measuring range of R2:025/0.45, 87.5 μm is used. The median particle size is reported as the x₅₀ value. A Sympatec RODOS dry dispersion unit is utilized with the following settings: vibration at a 50 to 60% feed rate; incoming air pressure at 85-90 psi; a primary air pressure RODOS of 3.5 bar; a 4 mm injector; and a depression of approximately 90, using a Karcher Vacuum and Sympatec Windox version 5 Software.

### EXAMPLES

The disclosed use of micronized calcium phosphates as viscosity modifying agents may be based on the capacity of soluble calcium for increasing the viscosity of a liquid nutritional composition and on the capacity of micronized calcium phosphate in a given median particle size for increasing soluble, i.e., bioavailable, calcium and phosphate in the nutritional compositions. These factors are demonstrated in Examples 1 and 2.

### Example 1

TCP is added to a commercially available liquid infant formula. The lot of TCP in the liquid infant formula was selected for each sample such that the soluble calcium contribution is increased. The viscosity of the resulting liquid infant formula is measured and the results are presented in Table I.

TABLE I

| | Soluble calcium | |
|---|---|---|
| | contribution from TCP, as | |
| | mg of TCP per liter of | |
| Sample Number | liquid infant formula | Viscosity (cp) |
| 1 | 50.2 | 13 |
| 2 | 89.6 | 13 |
| 3 | 140 | 15 |
| 4 | 142 | 14 |
| 5 | 149 | 52 |
| 6 | 159 | 36 |
| 7 | 163 | 67 |
| 8 | 170 | 64 |

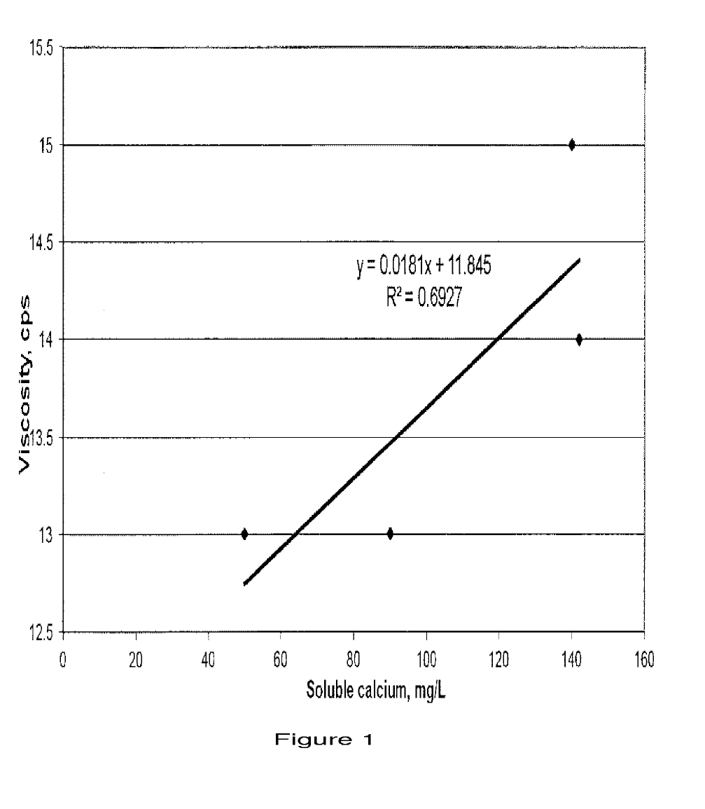

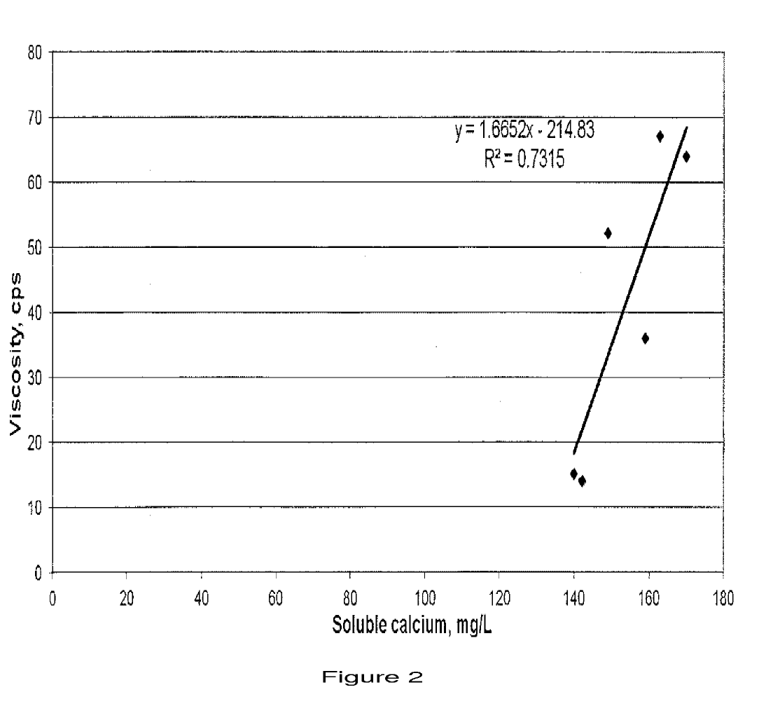

A plot of the data is shown in FIGS. 1 and 2. FIG. 1 demonstrates that the viscosity of the liquid infant formula does not change appreciably when the soluble calcium contribution from TCP is below about 140 mg TCP/L of formula. FIG. 2 demonstrates that the viscosity of the liquid infant formula increases sharply at about 149 mg of soluble calcium per L of formula.

### Example 2

Aqueous suspensions of 3.50 g/L of micronized TCP having decreasing median particle sizes are made. The soluble calcium in the resulting samples is measured and the results are set forth in Table II.

TABLE II

| | Low Al TCP¹ | | | |
|---|---|---|---|---|
| Sample | d₅₀ Median Particle | pH, | | |
| Number | Size (μm) | ambient^{a} | Ca/HCl^{b} | Soluble Ca(%)^{c} |
| 1 | 5.264 | 7.0 | 3.58 | 1.03 |
| 2 | 2.967 | 7.6 | 2.30 | 1.72 |
| 3 | 1.930 | 8.3 | 1.93 | 2.67 |
| 4 | 1.653 | 8.7 | 1.85 | 3.93 |
| 5 | 1.553 | 8.9 | 1.78 | 5.12 |
| 6 | 1.20 | 9.2 | 1.58 | 5.77 |
| 7 | 1.00 | 9.4 | 1.49 | 7.22 |
| 8 | 0.80 | 9.8 | 1.39 | 9.48 |
| 9 | 0.60 | 10.2 | 1.30 | 13.5 |
| 10 | 0.40 | 10.8 | 1.20 | 17.7 |
| 11 | 0.20 | 11.8 | 1.11 | 25.5 |

¹Low aluminum TCP is obtained from Morre-Tec Industries, Inc. (Union, NJ)
^{a}The pH of a 3.50 g/L suspension in water
^{b}Equivalents of soluble calcium per Equivalents of HCl required to reach pH 6.60
^{c}Soluble calcium, % of total theoretical calcium, at pH 6.60

As can be seen from Table II, it has surprisingly been discovered that the percentage of soluble calcium increases with decreasing TCP median particle size, particularly below 1.553 μm. In addition it can be seen that the ambient pH of the suspension in water increases with median particle size. Thus, the pH of the suspension is typically adjusted to a range of from about 6.6 to about 7.0 prior to addition of the other components in the nutritional composition.

On the basis of the discovery disclosed above, the TCP fortification rate and median particle size of micronized TCP are set such that the soluble calcium contribution yields a total protein/soluble calcium ratio (w/w) in the 200 to 700 range in four commercially available nutritional formulas each of which are available from Abbott Nutrition (Columbus, Ohio). This data is set forth in Table III:

TABLE III

| | Nutritional | Nutritional | Nutritional | Nutritional |
|---|---|---|---|---|
| | Formula 1 | Formula 2 | Formula 3 | Formula 4 |
| Total protein | 37 | 55 | 42 | 30 |
| (g/L) | | | | |
| Total Ca | 1300 | 850 | 705 | 1055 |
| (mg/L) | | | | |
| TCP | 2.70 | 1.86 | 1.72 | 1.78 |
| fortification | | | | |
| (g/L) | | | | |
| TCP particle | 1.20 μm | 0.60 μm | 0.80 μm | 0.80 μm |
| size median | | | | |
| (μm) | | | | |
| TCP soluble Ca | 62 mg/L | 100 mg/L | 65 mg/L | 67 mg/L |
| contribution | | | | |
| (mg/L) | | | | |
| Ratio of | 600 | 550 | 650 | 450 |
| total weight | | | | |
| of protein to | | | | |
| total weight | | | | |
| of soluble Ca | | | | |

What is claimed is:

1. A nutritional composition comprising at least one protein, at least one macronutrient other than the at least one protein, and micronized calcium phosphate having a median particle size from about 0.20 to about 1.20 micrometers, the composition having a viscosity from about 5 to about 5,000 centipoise.

2. The nutritional composition according to claim 1, wherein the micronized calcium phosphate has a median particle size from about 0.40 to about 1.00 micrometer.

3. The nutritional composition according to claim 1, wherein the micronized calcium phosphate has a median particle size from about 0.40 to about 0.80 micrometer.

4. The nutritional composition according to claim 1, wherein the micronized calcium phosphate is selected from the group of: micronized tricalcium phosphate; micronized dicalcium phosphate; micronized hydroxyapatite; and combinations thereof.

5. The nutritional composition according to claim 1, the composition having a viscosity from about 5 to about 3,000 centipoise.

6. The nutritional composition according to claim 5, the composition having a viscosity from about 10 to about 80 centipoise.

7. The nutritional composition of claim 1, comprising by weight percentage from about 0.001% to about 0.100% of soluble calcium.

8. The nutritional composition according to claim 1, comprising by weight percentage from about 0.5% to about 40% of total protein.

9. The nutritional composition according to claim 1, wherein the weight ratio of total protein to total soluble calcium is less than about 700:1.

10. The nutritional composition according to claim 9, wherein the weight ratio of total protein to total soluble calcium is from about 200:1 to about 700:1.

11. The nutritional composition according to claim 1, wherein the micronized calcium phosphate is present in the nutritional composition by weight percentage of from about 0.001% to about 1.0%.

12. The nutritional composition according to claim 1, wherein the weight ratio of total calcium to total phosphorus is from about 0.50 to about 3.0.

13. The nutritional composition according to claim 1, wherein the weight ratio of soluble calcium to total phosphate is from about 0.003 to about 1.00.

14. The nutritional composition according to claim 1, wherein micronized calcium phosphate is the only viscosity modifier added to the liquid nutritional composition.

15. The nutritional composition according to claim 1, wherein the composition is substantially free of viscosity modifiers selected from the group of: carrageenan; xanthan gum; gellan gum; gum Arabic; carboxymethylcellulose; and combinations thereof.

16. The nutritional composition according to claim 1 comprising by weight percentage of the composition, from about 0.02% to about 0.20% of total calcium.

17. The nutritional composition according to claim 1, comprising a calcium phosphate fortification rate of from about 0.5 to about 10 g of calcium phosphate per kg of the nutritional composition as fed.

18. The nutritional composition according to claim 1, wherein the nutritional composition is selected from a liquid, reconstitutable powder, or tablet.

19. A method of modifying the viscosity of a liquid nutritional composition comprising the step of adding micronized calcium phosphate having a median particle size of from about 0.20 to about 1.20 micrometers to a nutritional composition comprising at least one protein and at least one macronutrient other than the at least one protein.

20. The method according to claim 19, wherein micronized calcium phosphate is the only viscosity modifier added to the liquid nutritional composition.
